(19) United States
(12) Patent Application Publication
(10) Pub. No.: US 2026/0195797 A1
(43) Pub. Date: Jul. 9, 2026

(54) EMBEDDED PRODUCT SHOPPING EXPERIENCE

(71) Applicant: Wells Fargo Bank, N.A., San Francisco, CA (US)

(72) Inventors: John Bruno, Scottsdale, AZ (US); Joel Co, Phoenix, AZ (US); Deepika Dhanoria, Charlotte, NC (US); Udaya K. Isampalli, Tega Cay, SC (US); Jonathan Monzon, Castro Valley, CA (US); Mohit Puri, Castro Valley, CA (US); Kiran Yelimeli, Charlotte, NC (US)

(21) Appl. No.: 19/008,933

(22) Filed: Jan. 3, 2025

(51) Int. Cl. G06Q 30/0601; G06Q 10/0631

(52) U.S. Cl. CPC G06Q 30/0603; G06Q 10/06313; G06Q 30/0641

(57) ABSTRACT

A system is provided for facilitating the self-service onboarding and integration of financial products and services into third-party platforms. The system is configured to provide a catalog accessible to authorized users, including third-party developers or client users acting on behalf of a company. The catalog enables users to browse and request financial products or services, initiating an onboarding process that verifies regulatory compliance and aligns user entitlements for secure access. The system configures and facilitates bidirectional data-sharing connections between the financial institution and third-party platforms, ensuring compliance with applicable security protocols. Access to financial products or services is provided through pre-built micro frontend applications or cloud-based APIs, integrated into third-party platforms to deliver embedded user experiences. User experiences are dynamically adapted based on contextual insights and user roles, supporting secure and efficient provisioning of financial products and services.

### BACKGROUND

Financial institutions often face challenges in providing seamless, efficient, and secure access to their financial products and services. Traditional approaches to product discovery, onboarding, and integration often rely on manual and disjointed processes, leading to inefficiencies and fragmented user experiences. These challenges are exacerbated when client users, developers, or team members attempt to integrate financial products into third-party platforms, as the complexity of establishing secure data-sharing connections and aligning entitlements can delay implementation. Such delays hinder the institution's ability to deliver a unified, scalable solution that effectively meets organizational needs and enhances customer engagement.

Regulatory compliance further complicates the integration process. Financial institutions must adhere to strict requirements, including Know Your Customer (KYC) and Anti-Money Laundering (AML) protocols, to ensure legal compliance and data security. These requirements introduce additional burdens, requiring financial institutions and developers to navigate a complex landscape of compliance checks and access controls. The absence of a streamlined, self-service system capable of automating these processes and ensuring regulatory compliance has resulted in missed opportunities to enhance operational efficiency, improve customer experiences, and support dynamic and personalized interactions across diverse platforms.

### SUMMARY

Embodiments of the present disclosure relate to a system and method for enabling client users, developers, and team members to browse, request, and fulfill product requests for their respective organizations in a self-service and automated manner. The system facilitates seamless integration of financial products and services into third-party platforms, offering functionalities such as initiating instant payments, embedding capabilities within third-party systems, or interacting through application programming interfaces (APIs). The system supports onboarding processes tailored to specific organizational use cases, incorporating compliance measures such as KYC and AML checks, creating user credentials, and aligning entitlements to ensure secure and regulatory-compliant access. The system is further configured to adapt user experiences dynamically based on contextual insights and user roles, supporting secure provisioning and management of financial products.

In one embodiment, the system provides a catalog accessible through various modalities, including embedded micro frontend (MFE) applications hosted on third-party systems, developer portals, commercial client portals, and internal servicing portals. Users can initiate requests through MFEs, such as product catalogs or insights, while authenticated developers implement capabilities using APIs, SDKs, or MFEs following onboarding. The system enables secure bidirectional data-sharing connections between the financial institution and third-party platforms, ensuring data access complies with customer consent and security protocols. By generating contextual insights, the system can recommend financial products aligned with user interactions, streamlining engagement and enhancing operational efficiency. The modular and adaptable architecture of the system provides a scalable solution for integration requirements, maintaining regulatory compliance and supporting evolving organizational needs.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example computer system designed to facilitate the integration and management of financial products and services within third-party platforms.

FIG. 2 shows example logical components of the server device of FIG. 1.

FIG. 3 shows example logical components of a gateway module of the server device depicted in FIG. 2.

FIG. 4 shows additional example logical components of gateway module of FIG. 3.

FIG. 5 shows an example status display generated by the server device, as an example of the type of information provided by the onboarding module of FIG. 6.

FIG. 6 depicts an example connection between a third party platform and a micro-front end marketplace, facilitated by the system of FIG. 1.

FIG. 7 shows additional example logical components of marketplace module of FIG. 3.

FIG. 8 illustrates a method for integrating financial products and services into third-party platforms as implemented by the system of FIG. 1.

FIG. 9 shows example components of the server device of FIG. 1.

### DETAILED DESCRIPTION

The present disclosure generally relates to integrating financial products and services into third-party platforms that enables third-party developers to access a catalog of financial products and services, configure secure data-sharing connections, and manage user entitlements.

Financial institutions face significant challenges in providing seamless and efficient access to their financial products and services. Traditional methods for browsing, requesting, and fulfilling product requests often involve complex, manual processes, resulting in delays and fragmented user experiences. These inefficiencies affect client users, developers, and internal team members, who encounter hurdles in discovering available products, establishing secure data-sharing connections, and managing entitlements within partner systems. This complexity delays the onboarding and integration of financial products into third-party platforms, further hindering a unified and scalable solution for serving companies'specific use cases.

Regulatory compliance adds another layer of complexity. Requirements such as Know Your Customer and Anti-Money Laundering protocols must be addressed to ensure all data-sharing activities and financial transactions meet legal standards. Managing compliance, security, and user consent across disparate systems places a burden on both financial institutions and their partners. These challenges can limit institutions'ability to streamline operations, enhance customer engagement, and personalize financial offerings.

Financial institutions have traditionally relied on monolithic architectures to deliver their financial products and services. These architectures often consist of large, singular codebases designed to manage numerous functionalities under a unified structure. While such systems can be comprehensive, their rigidity and complexity make them difficult to update or scale. This inflexibility limits the institution's ability to support dynamic, granular, and tailored user experiences, often resulting in generalized solutions that fail to fully meet the specific needs of customers or business partners.

The challenges of monolithic architectures are particularly evident when financial institutions seek to introduce new capabilities or update existing services. Even minor adjustments can necessitate extensive resource allocation and significant downtime, delaying responses to evolving customer demands. Third-party systems, such as corporate enterprise resource planning (ERP) platforms like SAP S/4HANA and Oracle ERP Cloud, financial aggregators like Plaid or Yodlee, and other platforms such as customer relationship management (CRM) or e-commerce systems, often integrate with these monolithic architectures, further amplifying inefficiencies.

To address these challenges, embodiments of the present disclosure provide a system and method configured to enable client users, developers, and internal team members to browse, request, and fulfill product requests for their respective organizations in a self-service, automated manner. The system can provide these products as experience capabilities, which may include, but are not limited to, functionalities such as initiating instant payments, embedding mechanisms within third-party platforms, or interfacing through an API. The system can be configured to facilitate the onboarding of such products, incorporating due diligence processes such as KYC and AML compliance, creating user credentials, and aligning entitlements, all tailored to the specific use cases of the requesting organization.

In one embodiment, client users can be configured to initiate product requests through a product catalog MFE or an insight MFE hosted on a third-party system. Such users, authenticated and credentialed within the system, can provide consent for the requested capabilities. Developers, in contrast, may access the system to implement the requested capabilities via SDKs, APIs, or MFEs, subsequent to the completion of the onboarding process. The system can distinguish between these user roles, ensuring appropriate entitlements and access controls are maintained.

The system may support multiple modalities for interaction and integration. These modalities can include traditional SDK/API integration with third-party platforms; embedded MFEs configured to function via a control plane and experience platform; and MFEs accessible through portals, such as a developer portal, a commercial client portal, and an internal team member servicing portal. Additionally, the system can accommodate SDK or MFE integrations on third-party systems or marketing sites. Each modality can be configured to address specific operational and user requirements while maintaining a consistent and seamless experience.

The self-service product catalog capability of the system can simplify the process of discovering, requesting, and integrating financial products and services. The catalog can facilitate secure data-sharing connections and align entitlements with partner systems, ensuring compliance with regulatory requirements and operational policies. Contextual insights can be generated to guide users toward relevant requests and capabilities. For example, the system can recommend specific financial products, such as an instant payment capability, based on a prospective user's interaction with a marketing site. Such recommendations can streamline the onboarding process and facilitate efficient engagement with the system.

The system can further be configured to manage a variety of scenarios demonstrating its capabilities. These include, but are not limited to, enabling requests for access to instant payment functionalities, facilitating the sharing of account balance and transaction data between third-party platforms and the financial institution, managing user access and entitlements on connected systems, approving payment transactions, and providing access to reporting capabilities. Additional embodiments may allow administrators to align partner user entitlements for embedded experiences, such as payment approvals, or to manage user access across multiple platforms.

The modular architecture of the system ensures that the self-service onboarding process is adaptable and capable of addressing diverse user needs. By leveraging intelligent insights and a dynamic platform structure, the system provides a cohesive and scalable solution for integrating financial services into various operational contexts.

Embodiments of the present disclosure are rooted in computer technology and specifically address technical challenges associated with the integration of financial products and services into third-party platforms, particularly within the domain of online financial services. Traditional methods for such integrations often involve manual processes, disjointed user interfaces, and security concerns, which limit the efficiency and scalability of financial services in the digital environment. The system described herein overcomes these challenges by providing a streamlined, automated approach that is intrinsically tied to the use of computer systems and networks for facilitating secure, seamless data exchange between financial institutions and third-party platforms.

The system leverages an SDK, pre-built MFE applications, and cloud-based API functionality, all of which operate within a computer network infrastructure. These components address the complexities inherent to the digital financial services landscape, including real-time data sharing, secure access management, and regulatory compliance. The inclusion of MFEs and APIs represents a technical advancement over traditional, static methods of integrating financial services, as these tools enable dynamic, real-time interaction between users and financial data while maintaining the necessary security protocols. The use of MFEs, in particular, allows for modular, customizable interfaces that can be seamlessly embedded into third-party platforms, enhancing the end-user experience without requiring extensive manual development or modification of legacy systems.

Additionally, the system addresses the technical challenge of managing secure data sharing and user entitlements across disparate platforms. The ability to configure and synchronize secure data-sharing connections between financial institutions and third-party platforms is a technical solution that directly addresses the risks and inefficiencies of conventional methods. By enabling automated onboarding, including compliance checks such as KYC and AML protocols, the system ensures that access to sensitive financial data is governed by both regulatory requirements and technical safeguards. This combination of automated compliance and secure access management offers a solution that is both efficient and secure, reflecting the specific needs of online financial services in a digital landscape.

Furthermore, the system provides contextual insights based on real-time user interactions, which represents a technical improvement in the personalization and recommendation processes that are typically difficult to achieve in legacy systems. These insights enable the system to dynamically recommend financial products or services to users based on their specific needs and behaviors, while maintaining compliance with security and privacy requirements. The ability to process and analyze real-time data in this manner reflects a technical advancement that improves the overall efficiency and scalability of online financial services.

Further elaborations, nuances, and applications of systems utilizing micro front-ends, as described herein, are detailed in the following U.S. Patent Applications: U.S. patent application Ser. No. 17/663,572, filed on May 16, 2022, entitled “Micro Frontend (MFE) Contextual Experiences”; U.S. patent application Ser. No. 18/329,699, filed on Jun. 6, 2023, entitled “Individualized Contextual Experiences”; U.S. patent application Ser. No. 18/329,749, filed on Jun. 6, 2023, entitled “Micro-frontend Composition and Polymorphism”; U.S. patent application Ser. No. 18/333,222, filed on Jun. 12, 2023, entitled “Hub for Micro Front-End Service”; and U.S. patent application Ser. No. 18/519,707, filed on Nov. 27, 2023, entitled “Omni-Channel Micro Frontend Control Plane.” The content, teachings, and disclosures of the aforementioned patent applications are hereby incorporated by reference, to the extent that they do not conflict with the teachings presented herein.

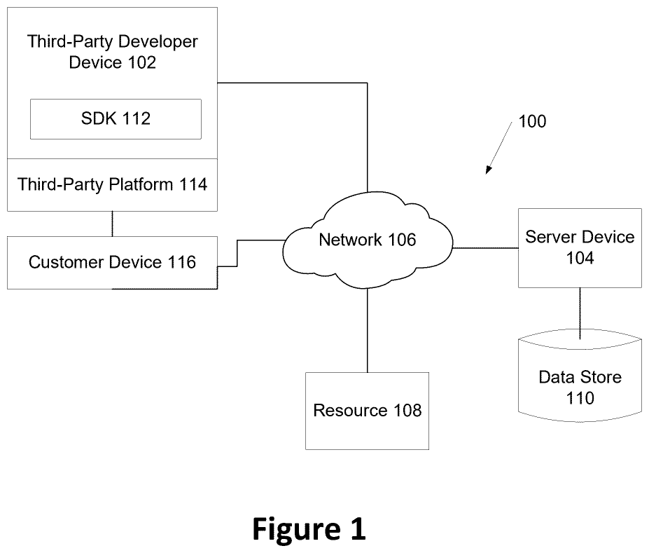

FIG. 1 illustrates a schematic of a computer system 100 configured to enable client users, developers, and team members to browse, request, and fulfill financial product requests for their respective companies in a self-service, automated manner. These products can take the form of experience capabilities, such as sending an instant payment, embedding features within a third-party platform, or accessing APIs. The computer system 100 facilitates the integration and management of financial products and services across various modalities. The system enables one or more third-party developer devices 102 and client user devices to connect with a server device 104 via a network 106. The SDK 112, accessible through a web portal or application, provides tools to develop and integrate financial products into a third-party platform 114. For example, the SDK 112 can enable embedding MFE applications or APIs for end users to request and utilize financial products and services.

A data store 110 can be connected to the server device 104 to securely store various types of data required for onboarding and integration processes. This data can include customer financial data, such as account information, transaction histories, user profiles, and entitlement management details. The data store 110 can also maintain records related to user interactions, compliance data (e.g., KYC and AML records), and data-sharing logs between third-party platforms and the financial institution. The data store 110 ensures that all stored data complies with applicable security protocols, regulatory standards, and user consent agreements.

The third-party developer device 102 and customer device 116 can include various computing devices, such as desktop computers, laptops, and integrated development environments, capable of interacting with the components of the system. The server device 104 may comprise one or more servers equipped with computing resources to perform complex tasks, including processing customer data, managing compliance checks, and handling interactions with the data store 110. The server device 104 also supports the deployment and orchestration of MFEs across the various modalities to deliver dynamic and tailored user experiences.

The network 106 can serve as the communication framework for computer system 100, enabling data exchange between the third-party developer devices 102 and the server device 104. The network 106 can also facilitate secure and reliable transmission of data and commands throughout the computer system 100, supporting real-time analysis and interaction with the financial products and services offered.

In some embodiments, computer system 100 can incorporate resource 108, which can include subscription-type services or external data services utilized in software development. Resource 108 can include of generative pre-trained transformers or other machine learning algorithms, enhancing the functionality of the system by improving the development and integration processes. In some embodiments, resource 108 can provide access to real-time data, such as asset prices or economic indicators useful for maintaining up-to-date and responsive financial services in a dynamic online environment.

Examples of third-party platforms 114 that can integrate with the system include corporate enterprise resource planning (ERP) systems, such as SAP S/4HANA, Oracle ERP Cloud, Microsoft Business Central, Oracle NetSuite, and Sage Intacct, which handle business processes like accounting and procurement. Additional examples include financial aggregators such as Plaid, Yodlee, and Finicity, which provide access to financial data from multiple sources. Other supported platforms include treasury management systems, accounting software like Intuit QuickBooks, Customer Relationship Management (CRM) systems, and e-commerce platforms that require interaction with financial services to manage transactions or customer payment data.

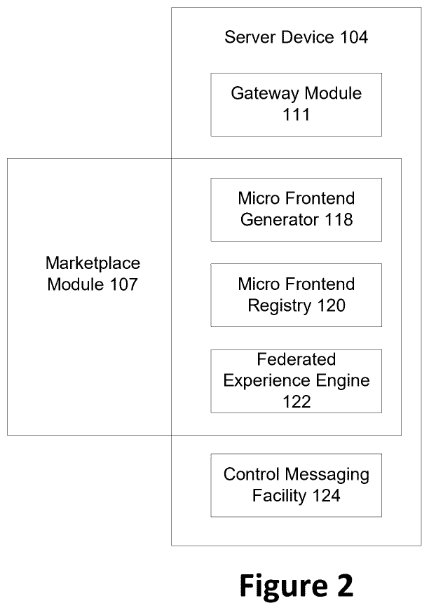

FIG. 2 illustrates a detailed embodiment of the server device 104 within computer system 100, outlining its components configured to enable the generation, storage, and management of MFE components. As shown in FIG. 2, server device 104 may include several modules, such as a gateway module 111, a marketplace module 107, and a control messaging facility 124. These components are structured to operate cohesively, facilitating the handling of MFEs within the system and ensuring the smooth exchange of data and commands between different parts of the system.

In certain embodiments, the gateway module 111 is configured to handle various operations related to customer identification, access management, onboarding, and entitlements. The gateway module 111 serves as an interface through which credentialed users on behalf of their companies, as well as third-party platforms, authenticate and interact with the computer system 100. By managing identification and authentication protocols, the gateway module 111 ensures that only authorized users are granted access to specific financial products or services within the system.

The gateway module 111 facilitates customer identification by verifying the identity of users attempting to access the system. This may include handling various forms of authentication, such as username/password combinations, multi-factor authentication, or other secure mechanisms. By incorporating advanced security measures, the gateway module 111 mitigates the risk of unauthorized access and ensures that sensitive financial data is protected.

In addition to customer identification, the gateway module 111 manages access control and entitlements. This involves determining and monitoring which users have permission to interact with specific products or services, including those accessed via embedded MFEs or APIs. The gateway module 111 dynamically maintains records of user roles, entitlements, and privileges to ensure compliance with security and regulatory requirements, as well as to align permissions with the specific capabilities requested by the user or company.

The onboarding process, facilitated by the gateway module 111, begins when a company, represented by a credentialed user, requests access to a financial product or service through an MFE (e.g., a product catalog MFE or insight MFE). Each product may have distinct regulatory requirements, such as KYC and AML protocols, which must be fulfilled as part of the onboarding process. These requirements may be automated where possible but may also include manual reviews to address product-specific or company-specific compliance needs. Once the onboarding process is complete, the user's entitlements are updated, and the requested product becomes accessible through the embedded MFE or via APIs/SDKs.

The entitlement management capabilities of the gateway module 111 ensure that users maintain appropriate permissions based on their roles, access levels, and the specific regulatory and operational requirements defined by the financial institution. These entitlements determine the actions a user can perform within the system, such as accessing financial data, initiating transactions, or interacting with specific MFEs. Entitlement updates are synchronized dynamically, enabling the system to remain compliant with evolving regulatory requirements and organizational policies.

The marketplace module 107 enables developers to browse and select from a catalog of pre-built MFEs, APIs, and SDKs that can be integrated into their platforms. The marketplace also allows developers to leverage third-party developed MFEs and utilities hosted on the Marketplace, providing a diverse and extensible set of options for creating customized experiences. Developers use these resources to integrate financial products and services, such as instant payments or wire transfer capabilities, into third-party platforms in accordance with their clients'specific needs.

Developers primarily interact with the system via a developer portal, which can include utilities, tools, and access to the marketplace. The portal can enable developers to integrate off-the-shelf MFEs (e.g., product catalog MFE or instant payment MFE) or utilize APIs and SDKs (e.g., instant payment APIs/documentation/sandbox) to build tailored experiences. These integrations can facilitate access to financial products following the completion of the onboarding process.

Once onboarded, the requested financial product is made available to the company through authorized product experiences. For example, an MFE to send a wire transfer may be automatically integrated into the user's interface upon completion of the onboarding process. The system's experience platform dynamically generates these capabilities, ensuring consistency and efficiency in how the financial product is accessed and utilized.

The marketplace module 107 also supports the retrieval and deployment of pre-built MFEs. Developers may embed these MFEs into third-party platforms, enabling end users to access financial products in a visually engaging and functional manner. For example, a product catalog MFE may allow end users to browse available products, request new capabilities, and initiate workflows to align user entitlements and data-sharing agreements with the requested functionality.

By enabling the selection, customization, and deployment of MFEs, the Marketplace and Developer Portal provide a robust framework for integrating financial products into third-party systems. Once integrated, these MFEs deliver an authorized product experience tailored to the needs of the end user. This modular approach allows developers to streamline the integration process while maintaining flexibility to meet specific business requirements and regulatory standards.

The micro front-end registry 120 can be configured to support both the development and storage of MFE components, functioning as a centralized directory or catalog of all available MFEs. This micro front-end registry 120 serves as a repository accessible by authorized users, such as developers within organizations connected to the computer system 100. For instance, developers associated with a financial institution may utilize the micro front-end registry 120 to craft MFEs that are subsequently deployed in various applications delivered to end-users. Each MFE in the micro front-end registry 120 may be developed in compliance with a Domain Specific Language (DSL), ensuring that all MFEs follow a standardized approach and consistent communication protocols across the system. The micro front-end registry 120 can include interactive features, enabling both automated and semi-automated methodologies for the creation of new MFEs. Developers may leverage wizards, pre-built templates, or other predefined functionalities to streamline the MFE development process, making it efficient and accessible.

The micro front-end registry 120 ensures that all stored MFE components adhere to required conformance criteria, including technical, design, and performance specifications. The micro front-end registry 120 incorporates programming logic to validate each MFE against these predefined standards, ensuring compatibility with computer system 100. This validation process enables a consistent level of quality across all MFEs, facilitating their integration into larger systems. By ensuring that each MFE complies with a standardized DSL, the micro front-end registry 120 maintains uniformity in communication protocols between MFEs and across the system. The conformance criteria may include specific requirements related to the programming languages used, adherence to data security protocols, and compliance with performance benchmarks. By enforcing these standards, the micro front-end registry 120 preserves the integrity and reliability of the MFEs within the system.

In addition to supporting MFE creation and validation, the micro front-end registry 120 functions like a catalog, cataloging a comprehensive collection of products representing a distinct MFE or collection of MFEs developed in accordance with specific guidelines. The registry serves as a structured resource that developers can access to retrieve and utilize stored MFEs for the development of user interfaces. The MFEs within the micro front-end registry 120 are indexed based on various parameters, such as their function, usage context, or other distinguishing attributes, ensuring efficient retrieval and application. Furthermore, the micro front-end registry 120 allows for the combination of two or more MFEs, facilitating the creation of new, more complex components by integrating pre-existing functionalities. This organized structure enhances the versatility and scalability of the micro front-end registry 120, supporting the rapid development and deployment of tailored user interfaces across the system.

The federated experience engine 122 is designed to retrieve information from the micro front-end registry 120 and utilize these resources to render or display user experiences. The term “federated” implies that these engines can function collaboratively or independently, sourcing resources from different domains, which allows for flexibility and scalability in managing and presenting user experiences. The federated experience engine 122 is responsible for orchestrating user experiences across multiple communication channels, ensuring consistent and optimized interactions tailored to each channel's characteristics. The federated experience engine 122 operates as a computational entity that facilitates the alignment of user interactions through distinct communication paths, thereby enabling the seamless integration and performance of MFE components within computer system 100.

In some embodiments, the federated experience engine 122 defines one or more APIs that allow for the registration of new MFEs within the micro front-end registry 120. This registration may be conducted using contracts, such as JavaScript Object Notation (JSON) contracts, which define the conformance criteria for each MFE. The federated experience engine 122 ensures that all MFEs comply with these criteria, which cover technical, design, and performance standards. By managing both the “control” aspects, which govern how standard capabilities are enforced, and the “data” aspects, which dictate how each MFE behaves and responds to user interactions, the federated experience engine 122 ensures that the MFEs operate smoothly and consistently within computer system 100. In some cases, the federated experience engine 122 is geared toward providing use case agnostic MFEs, indicating that the MFEs are versatile and adaptable to various use cases or scenarios, irrespective of the specific application or context.

The federated experience engine 122 supports the personalization of user experiences by considering factors such as user role entitlements, user preferences, and artificial intelligence-driven suggestions for MFEs based on user behavior or other relevant parameters. The engine ensures that MFEs integrate seamlessly with the control plane, enabling features such as state transitions, analytical data collection, activity tracking, and experimental features like deep linking and feedback provision. The federated experience engine 122 also retrieves MFEs from the micro front-end registry 120, ensuring that these components adhere to the system's technical guidelines, such as compliance with designated programming languages and encryption standards, as well as design attributes related to interface aesthetics and performance benchmarks like rendering speed and computational efficiency. This functionality allows the system to flexibly adapt to different scenarios while ensuring efficient and secure user interactions.

The control messaging facility 124 is configured to manage communication between the various components of computer system 100. Specifically, the control messaging facility 124 ensures the efficient and seamless exchange of messages between control plane user interface extensions that are associated with distinct communication channels. The control messaging facility 124 adopts standardized communication protocols and formats, which can be important in maintaining the integrity of interactions across different components. By standardizing these protocols, the control messaging facility 124 can ensure that messages are exchanged without error, enabling effective coordination between MFE components and other system elements.

The control messaging facility 124 incorporates mechanisms for queuing, prioritizing, and routing messages, allowing for dynamic message handling based on predefined rules or conditions. For example, certain messages may be prioritized based on their relevance to user interactions or system performance, while others may be queued for later processing. This structured approach to message management ensures that all messages are delivered to their intended recipients in a timely and organized manner. Additionally, the routing mechanisms within the control messaging facility 124 enable messages to be directed to specific system components, such as MFEs or federated experience engines, based on the content and context of the message.

By overseeing communication between control plane user interface layer extensions, the control messaging facility 124 ensures that interactions occurring on one channel can influence or inform user experiences on another channel. For example, if an interaction on one channel triggers a state transition or analytics collection, the control messaging facility 124 can relay this information to another channel, ensuring that the user experience remains consistent and interconnected. This cross-channel communication capability allows the system to provide a cohesive user experience, even when multiple MFEs are operating across different platforms or devices. The control messaging facility 124 thus plays a pivotal role in ensuring the proper coordination and functionality of the various components within computer system 100.

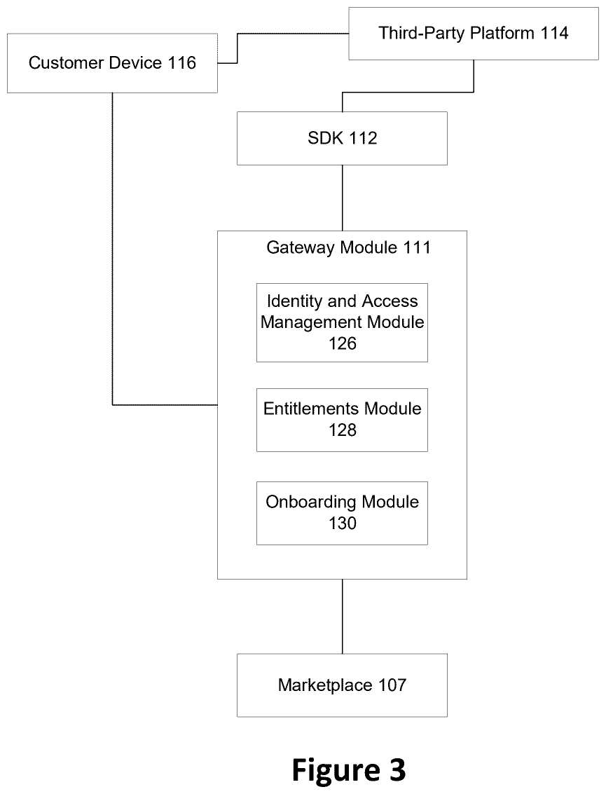

FIG. 3 illustrates the gateway module 111, which provides a connection between the customer device 116 and the marketplace module 107. The marketplace module 107, in conjunction with the gateway module 111, allows credentialed users to request and utilize MFEs and APIs from the marketplace, enabling seamless integration into their platforms. In some embodiments, the gateway module 111 enables the integration of financial products and services into the third-party platform 114.

The gateway module 111 can include several components to manage security, access control, and onboarding. One such component is the identity and access management module 126, which ensures secure authentication, identity verification, and authorization of users interacting with the system. Additionally, the gateway module 111 incorporates the entitlements module 128 and the onboarding module 130 to facilitate a smooth and compliant process for accessing financial products and services.

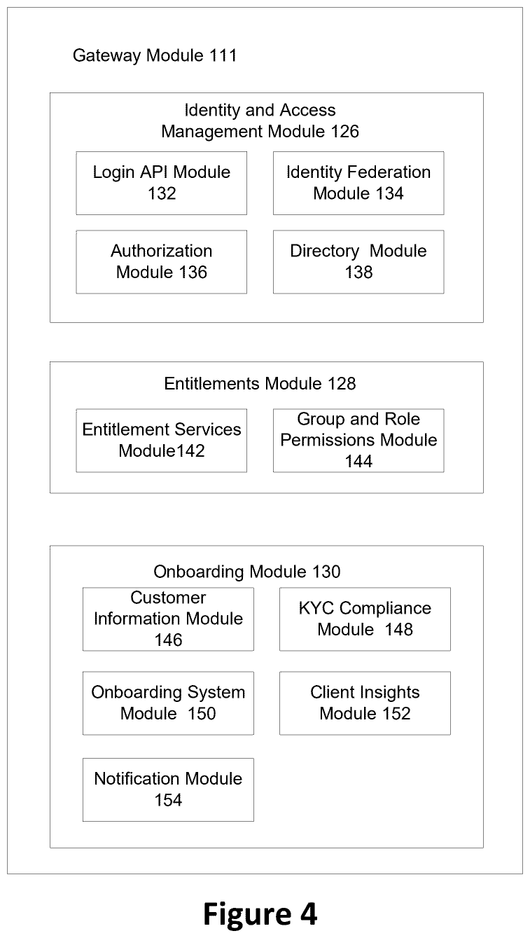

As further depicted in FIG. 4, the identity and access management module 126 can include a login authentication module 132, identity federation module 134, authorization module 136, and user directory management module 138, which can work together to ensure that only authorized and credentialed users can access the system and its resources, while securely managing identity data.

In some embodiments, the entitlements module 128, ensures users have appropriate permissions and access rights within the system. The entitlements module 128 can include an entitlement services module 142 and group and role permissions module 144 to manage user entitlements, ensuring compliance with organizational policies and regulatory requirements. For instance, administrators can assign or modify access rights based on user roles or business needs, streamlining entitlement management for large organizations.

The onboarding module 130 can oversee the process of bringing new users and companies into the system. The onboarding module 130 can incorporate a workforce and customer information module 146, KYC compliance module 148, and onboarding system module 150. The onboarding process ensures that all regulatory requirements are met before granting access to requested financial products or services.

Additionally, a client insight module 152 can analyze user behavior and needs, generating contextual insights to personalize onboarding and recommend relevant financial products or services. For example, a company requesting access to wire transfer services via an MFE hosted on the third-party platform can receive tailored insights that guide them through the onboarding process efficiently.

Once a company is onboarded, a notification module 154 can provides updates on the status of requests, such as the completion of compliance checks or activation of financial services. Notifications ensure that both administrators and users are informed at each step of the process, enhancing transparency and user engagement.

With continued reference to FIG. 3, the marketplace module 107 can enable developers to access a library of pre-built MFEs and APIs for integrating financial products into third-party platforms. Developers interact with the system through the Developer Portal, which provides tools, documentation, and access to off-the-shelf MFEs and SDKs (e.g., product catalog MFE, instant payments SDK).

Once onboarded, companies gain access to authorized product experiences. For example, an MFE for sending wire transfers may automatically become available within the company's platform upon the completion of the onboarding process. This functionality is dynamically provisioned by the system's experience platform.

Developers embedding these capabilities via SDKs or APIs can ensure seamless integration and a consistent user experience. The system's modular approach enables efficient deployment of MFEs, reducing development time while maintaining compliance with regulatory standards.

The client insight module 152 can further support the receipt of expressions of interest from users interacting with MFEs or contextual recommendations. For instance, a user browsing financial tools may be prompted to request access to a wire transfer service, with the system automatically initiating the onboarding workflow upon receiving their request.

Contextual insights generated by the system may be tailored to the user's needs, driving engagement by presenting relevant options at the right time. For example, the system may recommend international payment services to a user frequently navigating related resources. Such insights enhance user interaction with financial products in a meaningful and efficient manner.

The notification module 154 ensures timely communication throughout these processes, providing alerts related to onboarding, entitlement updates, and product activations. Notifications are designed to keep users informed and streamline their interactions with the system.

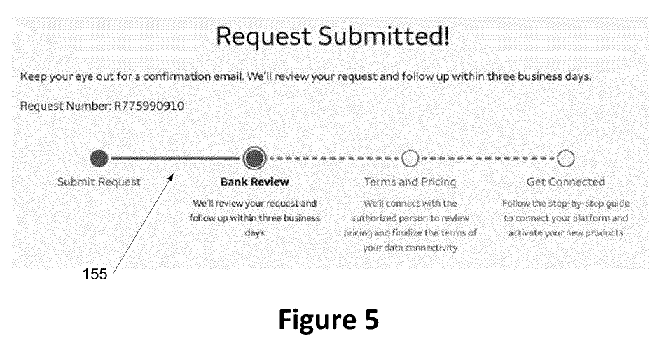

As depicted in FIG. 5, the notification module 154 can be further be configured to provide a status display 155 of the onboarding process, providing a detailed view of each step involved. This may include steps such as submitting the onboarding request, bank review, terms and pricing negotiations, and getting connected to the financial services system. The notification module 154 provides a real-time indication of where the user is in the onboarding method, allowing both the user and system administrators to track progress at each phase of the process.

Additionally, the notification module 154 can send follow-up correspondence, such as emails or text messages, to inform users of their progression to the next step in the process. For example, once the KYC checks have been completed, the notification module 154 may send an alert indicating that the user has moved on to the next stage, such as account setup or service activation. This ensures that users remain informed throughout the entire onboarding lifecycle, reducing uncertainty and enhancing the overall experience. Other types of notifications and alerts are also contemplated, including reminders, escalations for incomplete steps, or notifications related to regulatory compliance updates.

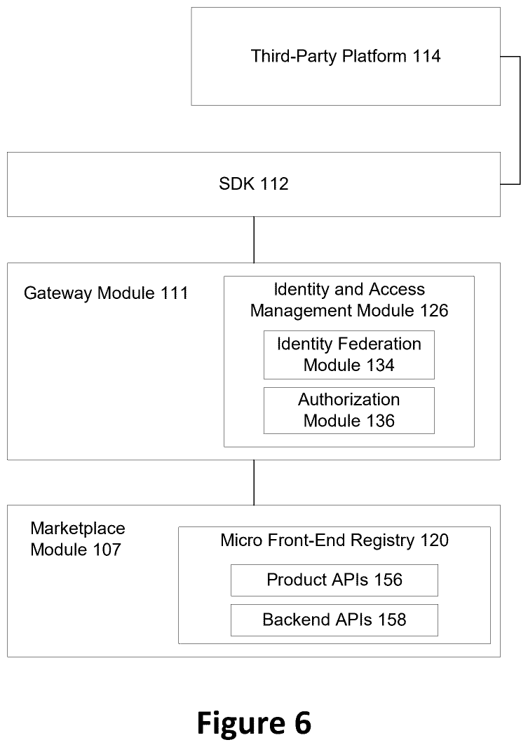

FIG. 6 depicts the SDK 112 connected to the marketplace module 107 through the gateway module 111. The SDK 112 interfaces with the third-party platform 114, enabling MFE components from the marketplace module 107 to be embedded into the third-party platform 114. This integration allows third-party developers to easily incorporate financial products and services into their platforms by embedding MFEs from the marketplace module 107.

The gateway module 111 includes the identity and access management module 126, which contains the identity federation module 134 and the authorization module 136. The identity federation module 134 manages identity federation, allowing for single sign-on functionality across multiple services and systems, enabling users to authenticate once and access multiple systems securely. The authorization module 136 can enforce authorization policies, determining access rights and controlling which users can access specific resources or services within the system, ensuring that permissions are properly managed based on user roles and entitlements.

The marketplace module 107 can also include a micro front-end registry 120, which stores both product APIs 156 and backend APIs 158. The product APIs 156 enable external interactions with specific financial products or services. For example, product APIs might allow third-party platforms to integrate services such as account creation, loan applications, or real-time payment processing into their user interfaces. These APIs make it easier for developers to embed specific functionality related to financial products directly into their systems.

The backend APIs 158, on the other hand, manage internal system functions such as database queries, transaction processing, and user authentication, ensuring that services operate smoothly without direct user interaction. For instance, backend APIs handle communication between the system's internal components, managing data storage, retrieving account information, or verifying user identities.

In some cases, product APIs 156 may be composed of a plurality of backend APIs 158. For example, a product API enabling a payment transaction might rely on multiple backend APIs to handle user authentication, transaction authorization, and payment processing, thus allowing the external-facing product API to provide a seamless user experience while leveraging multiple backend systems. This modularity allows for greater flexibility and scalability, as individual backend APIs can be reused across different product APIs.

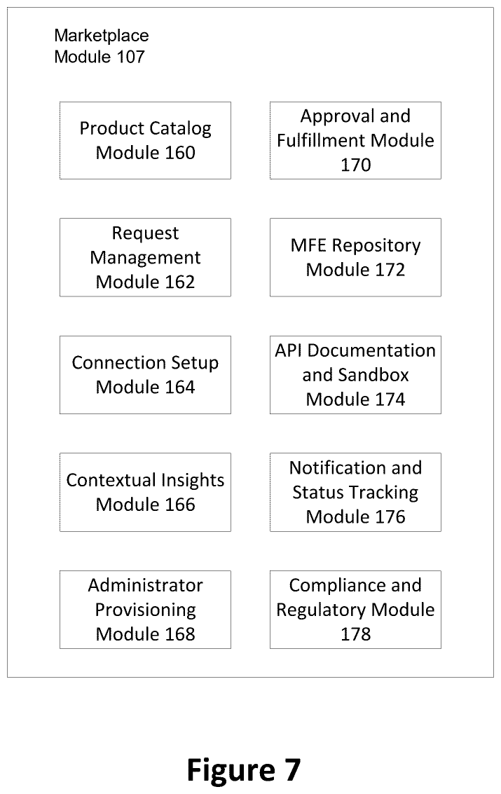

FIG. 7 illustrates the marketplace module 107, which in some embodiment is configured to enable client users, developers, and team members to browse, request, and fulfill product requests for their respective companies in a self-service automated manner. The marketplace module 107 facilitates interactions across various modalities, including embedded MFEs within third-party platforms, access through developer portals, client portals, internal servicing portals, and SDK-based solutions. This infrastructure allows seamless connection to financial products and services while maintaining rigorous compliance with regulatory and operational requirements.

At the core of the marketplace module 107 is the product catalog module 160, which can serve as an organized repository of available financial products and services. The product catalog module 160 can enable users to browse offerings tailored to their roles and preferences, providing an intuitive interface for exploring and requesting capabilities such as instant payments, reporting services, and more. To manage these requests, the request management module 162 can coordinate workflows for approval, entitlement alignment, and compliance checks. This module ensures that all product requests are processed efficiently, aligning with both user needs and organizational policies.

Once a product request is submitted, the connection setup module 164 facilitates the establishment of secure data-sharing connections between third-party platforms and the financial institution. This module ensures bidirectional data flow while adhering to customer consent requirements and maintaining robust security protocols. Complementing this functionality, the contextual insights module 166 can use intelligent algorithms to analyze user behavior and preferences, generating personalized recommendations for financial products or services. These insights are presented through MFEs and allow users to seamlessly initiate product requests directly from the recommendations.

To enhance administrative control, the administrator provisioning module 168 can allow authorized administrators to manage access on behalf of other users. This can include provisioning connections, updating entitlements, and overseeing user roles within the system. Meanwhile, the approval and fulfillment module 170 can oversee the automated and semi-automated approval processes, ensuring compliance with industry standards, regulatory requirements, and company-specific guidelines. In some embodiments, the approval and fulfillment module 170 can facilitate efficient product onboarding, enabling users to access requested products with minimal delays.

Supporting these operations is the MFE repository module 172, which can serve as a centralized store for pre-built MFEs and APIs. The MFE repository module 172 can support deployment across various platforms, including embedded systems, developer portals, and internal or client-facing portals. The MFE repository module 172 can be complemented by the API documentation and sandbox module 174, which can provide developers with the resources necessary for integration, which can include API specifications, integration guides, and sandbox environments for testing and validating new product implementations.

The notification and status tracking module 176 can ensure transparent communication by providing users, administrators, and developers with real-time updates regarding the status of requests, approvals, and onboarding workflows. To maintain compliance throughout these processes, the compliance and regulatory module 178 can manage checks such as identity verification, KYC/AML protocols, and risk assessments. Additionally, the notification and status tracking module 176 can ensure that all interactions adhere to the necessary legal and regulatory standards, safeguarding the integrity of the system.

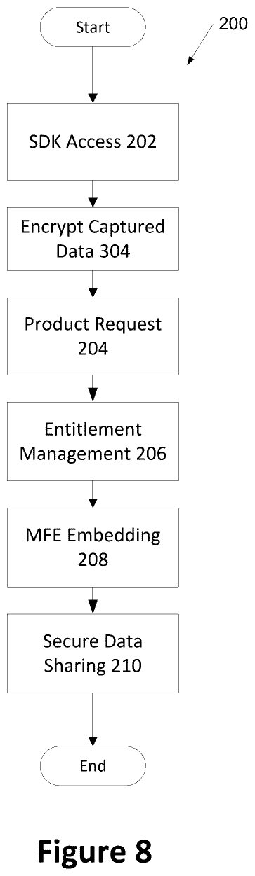

FIG. 8 illustrates a method 200 as one modality for integrating financial products and services into third-party platforms, specifically through a software development kit. The method 200 involves several steps that facilitate secure access to a comprehensive catalog of financial products and services through a software development kit, enabling third-party developers to embed micro front-end components and application programming interface functionalities into their platforms. Method 200 allows for seamless integration and management of financial services, enhancing the end-user experience.

In step 202, the third-party developer initiates the method by accessing the SDK 112 via the third-party developer device 102. This SDK 112 can include a catalog of financial products and services stored in the marketplace module 107. By interacting with the SDK 112, developers can browse the available products and services, and select those relevant to their own platform's integration needs. The SDK also provides necessary tools, documentation, and libraries, enabling a streamlined process for integrating financial services.

In step 204, after accessing the SDK, the third-party developer can submit a request to access a particular financial product or service. This request can be processed through the gateway module 111, which can handle customer identification and access management through components such as the identity and access management module 126. The request may require the developer to pass authentication via the identity federation module 134 or the authorization module 136 to verify their credentials and entitlements to access the requested financial product. This step ensures that only authorized developers proceed with further integration.

In step 206, entitlement management can be carried out through the entitlements module 128, which can ensure the proper configuration of access permissions based on the developer's role and product entitlements. Subcomponents of the entitlements module 128, such as the entitlement services module 142 and group and role permissions module 144, can dynamically synchronize and configure the developer's entitlements to control their access to the financial institution's products. This ensures that the developer is granted access in a secure and compliant manner.

In step 208, the requested financial products or services can be delivered to the third-party platform 114 via pre-built MFE components. These MFEs can be generated by the micro front-end generator 118, tailored for integration into the third-party platform 114. The MFEs can be retrieved from the micro front-end registry 120 and orchestrated across various channels by the federated experience engine 122, which can ensure that the integration is smooth and optimized for the third-party platform's user interface.

In step 210, secure data sharing is enabled between the financial institution and the third-party platform 114. The product APIs 156 and backend APIs 158, stored within the micro front-end registry 120, can facilitate this data exchange, ensuring compliance with relevant regulations such as KYC and AML requirements. The control messaging facility 124 can manage the secure and structured communication between the financial institution and the third-party platform, maintaining data integrity throughout the integration process.

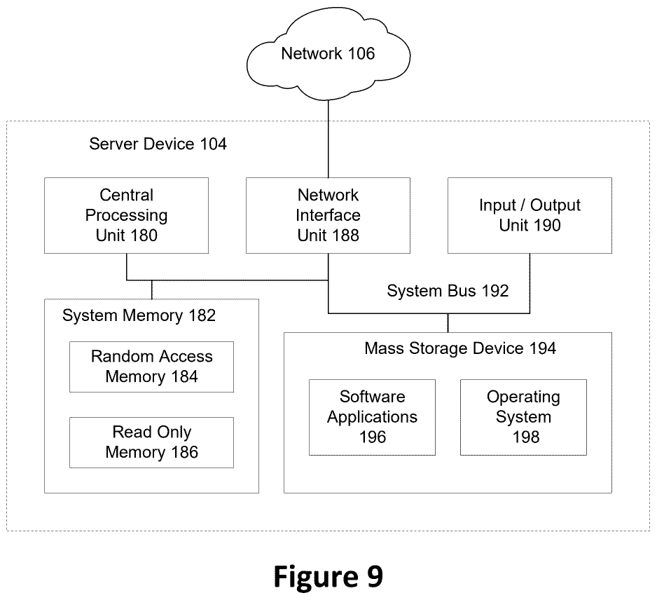

As illustrated in the embodiment of FIG. 9, the example server device 104, which provides the functionality described herein, can include at least one Central Processing Unit (CPU) 180, a system memory 182, and a system bus 192 that couples the system memory 182 to the CPU 180. The system memory 182 includes a Random Access Memory (RAM) 184 and a Read-Only Memory (ROM) 186. A basic input/output system containing the basic routines that help transfer information between elements within the server device 104, such as during startup, is stored in the ROM 186. The server device 104 further includes a mass storage device 194. The mass storage device 194 can store software instructions and data. A central processing unit, system memory, and mass storage device similar to that shown can also be included in the other computing devices disclosed herein.

The mass storage device 194 is connected to the CPU 180 through a mass storage controller (not shown) connected to the system bus 192. The mass storage device 194 and its associated computer-readable data storage media provide non-volatile, non-transitory storage for the server device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, Digital Versatile Discs (DVDs), other optical storage media, magnetic cassettes, magnetic tape, magnetic disk storage or other magnetic storage devices, or any other medium which can be used to store the desired information and which can be accessed by the server device 104.

According to various embodiments of the invention, the server device 104 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server device 104 may connect to network 106 through a network interface unit 188 connected to the system bus 192. It should be appreciated that the network interface unit 188 may also be utilized to connect to other types of networks and remote computing systems. The server device 104 also includes an input/output controller 190 for receiving and processing input from a number of other devices, including a touch user interface display screen or another type of input device. Similarly, the input/output controller 190 may provide output to a touch user interface display screen or other output devices.

As mentioned briefly above, the mass storage device 194 and the RAM 184 of the server device 104 can store software instructions and data. The software instructions include an operating system 198 suitable for controlling the operation of the server device 104. The mass storage device 194 and/or the RAM 184 also store software instructions and applications 196, that when executed by the CPU 180, cause the server device 104 to provide the functionality of the server device 104 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system, comprising:
at least one processor; and
non-transitory computer-readable storage storing instructions that, when executed by the at least one processor, cause the system to:
provide a catalog identifying a plurality of financial products or services supported by a financial institution, wherein the catalog is accessible to an authorized user, including a third-party developer or a client user, acting on behalf of a company;
enable the authorized user to browse the catalog and request access to at least one financial product or service, wherein the request initiates a self-service onboarding process configured to verify compliance with one or more regulatory requirements, and align user entitlements for secure access;
configure and facilitate a data-sharing connection between the financial institution and a third-party financial platform, wherein the data-sharing connection enables bidirectional data exchange and comply with applicable security protocols;
provide access to the at least one financial product or service through one or more pre-built micro frontend applications or cloud-based application programming interfaces, wherein the one or more pre-built micro frontend applications or application programming interfaces are integrated into the third-party financial platform or other user interfaces to deliver embedded user experiences; and
adapt user experiences based on contextual insights and user roles, enabling secure access and provisioning of financial products or services.

2. The system of claim 1, wherein the instructions that, when executed by the at least one processor, facilitate an onboarding process wherein the authorized user is approved to access to financial data.

3. The system of claim 2, wherein the onboarding process includes automated compliance checks, including Know Your Customer checks and Anti-Money Laundering checks, to ensure regulatory compliance.

4. The system of claim 1, wherein the instructions, when executed by the at least one processor, synchronize user entitlements between the authorized user and the financial institution.

5. The system of claim 1, wherein the third-party financial platform is at least one of a corporate enterprise resource planning system or a financial aggregator.

6. The system of claim 1, wherein the instructions that, when executed by the at least one processor, provide notifications to the authorized user regarding at least one of an onboarding status, integration of the at least one financial product or service, or an entitlement update.

7. The system of claim 1, wherein the instructions, when executed by the at least one processor, provide a specialized catalog identifying a subset of financial products or services tailored to business needs and preferences of the authorized user.

8. The system of claim 1, wherein the instructions, when executed by the at least one processor, generate contextual insights based on a customer interaction with the authorized user, and recommend additional products or services that align with business needs or preferences of the authorized user.

9. The system of claim 1, wherein the instructions, when executed by the at least one processor, facilitate a receipt of an expression of interest in one or more of the plurality of financial products or services supported by the financial institution originating from the authorized user.

10. The system of claim 9, wherein the instructions, when executed by the at least one processor, further cause the system to transmit the expression of interest to a sales and support team.

11. A method, comprising:
providing a catalog identifying a plurality of financial products or services supported by a financial institution, wherein the catalog is accessible to an authorized user, including a third-party developer or a client user, acting on behalf of a company;
enabling the authorized user to browse the catalog and request access to at least one financial product or service, wherein the request initiates a self-service onboarding process configured to verify compliance with one or more regulatory requirements and align user entitlements for secure access;
configuring and facilitating a data-sharing connection between the financial institution and a third-party financial platform, wherein the data-sharing connection enables bidirectional data exchange and complies with applicable security protocols;
providing access to the at least one financial product or service through one or more pre-built micro frontend applications or cloud-based application programming interfaces, wherein the one or more pre-built micro frontend applications or cloud-based application programming interfaces are integrated into the third-party financial platform or other user interfaces to deliver embedded user experiences; and
adapting user experiences based on contextual insights and user roles, enabling secure access and provisioning of financial products or services.

12. The method of claim 11, further comprising facilitating an onboarding process wherein the authorized user is approved to access financial data.

13. The method of claim 12, wherein the onboarding process includes performing automated compliance checks, including Know Your Customer checks and Anti-Money Laundering checks, to ensure regulatory compliance.

14. The method of claim 11, further comprising synchronizing user entitlements between the authorized user and the financial institution.

15. The method of claim 11, wherein the third-party financial platform comprises at least one of a corporate enterprise resource planning system or a financial aggregator.

16. The method of claim 11, further comprising providing notifications to the authorized user regarding at least one of an onboarding status, integration of the at least one financial product or service, or an entitlement update.

17. The method of claim 11, further comprising providing a specialized catalog identifying a subset of financial products or services tailored to business needs and preferences of the authorized user.

18. The method of claim 11, further comprising generating contextual insights based on a customer interaction with the authorized user and recommending additional products or services that align with business needs or preferences of the authorized user.

19. The method of claim 11, further comprising facilitating a receipt of an expression of interest in one or more of the plurality of financial products or services supported by the financial institution originating from the authorized user.

20. The method of claim 19, further comprising transmitting the expression of interest to a sales and support team.
